(19) United States
(12) Patent Application Publication
(10) Pub. No.: US 2025/0093833 A1
(43) Pub. Date: Mar. 20, 2025

(54) COMPUTERIZED SYSTEMS AND METHODS FOR CONTEXTUAL GESTURE-BASED CONTROL OF CONNECTED DEVICES

(71) Applicant: PLUME DESIGN, INC., Palo Alto, CA (US)

(72) Inventors: Rok VIDMAR, Ljubljana (SI); Gašper ŠTUKELJ, Maribor (SI)

(21) Appl. No.: 18/823,783

(22) Filed: Sep. 4, 2024

Related U.S. Application Data
(60) Provisional application No. 63/582,569, filed on Sep. 14, 2023.

(51) Int. Cl. G05B 19/042; G06F 3/01

(52) U.S. Cl. CPC G05B 19/042; G06F 3/017; G05B 2219/2642

(57) ABSTRACT

Disclosed are systems and methods that via the disclosed functionality, can involve receiving, from a wearable included in a controlled network, data representative of a gesture executed by a wearer of the wearable. The systems and methods may additionally include recognizing, based on the data representative of the gesture, the gesture executed by the wearer. The system and method may also include identifying, via at least one location sensor, a physical location of the wearer. The system and method may also include directing, based on the gesture executed by the wearer and the physical location of the wearer, a management device included in the controlled network to execute a management action. Various other systems, methods, and computer-readable media are also disclosed.

### CROSS-REFERENCE TO RELATED APPLICATIONS

This application claims the benefit of U.S. Provisional Application No. 63/582,569, filed Sep. 14, 2023, which is incorporated by reference in its entirety.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for contextual gesture-based control of connected devices according to some embodiments of the instant disclosure.

FIG. 2 is a block diagram of an example system that implements a system for contextual gesture-based control of connected devices according to some embodiments of the instant disclosure.

FIG. 3 is a flow diagram of an example method for contextual gesture-based control of connected devices according to some embodiments of the instant disclosure.

FIG. 4 illustrates example gestures that a wearer of a wearable device may execute according to some embodiments of the instant disclosure.

FIG. 5 shows a floorplan of an example smart home with a first zone and a second zone according to some embodiments of the instant disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The recent explosion of low-cost and feature rich smart home devices has raised new and unresolved issues with user control of such connected devices. Exiting user control methodologies for connected devices (e.g., Internet of Things (IoT) devices, smart home devices, and the like) generally rely on conventional controls or smartphones, which essentially function as advanced remote controls.

Conventional efforts have involved the introduction of more natural controls to smart homes, such as via voice recognition. However, using conventional voice recognition often feels burdensome, and may raise privacy concerns as some devices may constantly listen for potential inputs. Additionally, voice recognition systems may be based on biased data and may therefore struggle to work effectively across diverse demographic groups. There are also technical limitations, as voice-based models require extensive data gathering and training, resulting in limited generalization. Hence, the instant disclosure identifies and addresses the shortcomings for new systems and methods for user control of connected devices, among other benefits, as evident from the disclosure herein.

The present disclosure is generally directed to systems and methods for contextual gesture-based control of connected devices. As discussed in more detail below, some embodiments of the present disclosure may receive, from a wearable (e.g., a smart ring, a smart watch, a mobile phone, and the like) included in a controlled network, data representative of a gesture executed by a wearer of the wearable. Embodiments may also recognize, based on the data representative of the gesture, the gesture executed by the wearer, and may identify, via at least one location sensor included in the controlled network, a physical location of the wearer. In some examples, embodiments may also direct, based on the gesture executed by the wearer and the physical location of the wearer, a management device included in the controlled network to execute a management action.

In some examples, embodiments may further identify and incorporate into an analysis an additional context associated with the wearer (e.g., a time of day that the wearer executes the gesture, network activity of devices included in the controlled network, a location and/or proximity to the wearer of an additional user, and so forth). Moreover, in additional or alternative examples, embodiments may determine that the data representative of the gesture exceeds a predetermined complexity threshold and may communicate with an external gesture recognition device to recognize the gesture.

Embodiments of this disclosure may enable users to effortlessly control their smart devices using simple gestures. This approach eliminates privacy concerns and offers improved performance across various user groups. Embodiments may enhance gesture-based recognition by incorporating rich contextual information derived from the network or connectivity it is connected to. For instance, by utilizing triangulation data to determine the user's location at the time of the gesture, a single gesture can trigger a customized action from the most relevant device or edge.

Furthermore, some embodiments may leverage computational power of secondary edges to employ machine learning models that may not feasibly operate within local networks and/or wearable devices. Hence, the systems and methods of this disclosure may enable a higher quality of service and enhanced performance for connected devices.

In comparison to existing control systems (e.g., voice-recognition based control systems), embodiments of the systems and methods for contextual gesture-based control of connected devices disclosed herein may offer several significant advantages. For example, voice recognition can be fraught with complexities and challenges, including handling a wide range of accents, dialects, speech impediments, and background noise. This may result in a higher demand for computational resources and complexity to train such models effectively. In contrast, gestures may tend to be more uniform across different users, significantly simplifying the training process for machine learning models. Such gesture-based models may be less likely to be affected by individual differences or environmental factors, leading to more reliable and efficient recognition. Therefore, a gesture-based control system can offer improved consistency, accuracy, and ease of use, making it a compelling alternative to traditional control systems.

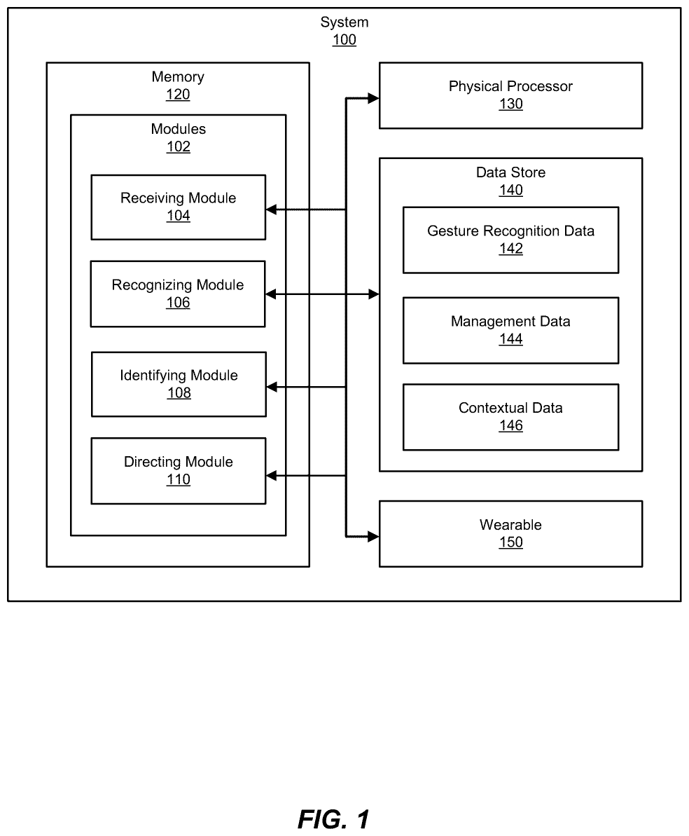

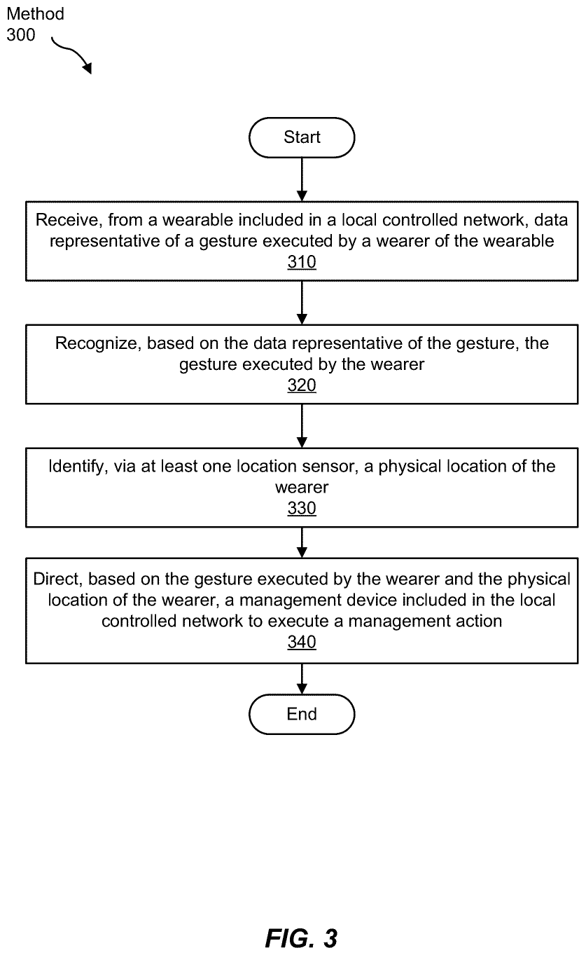

The following will provide, with reference to FIGS. 1-2 and 4-5, detailed descriptions of systems for contextual gesture-based control of connected devices. Detailed descriptions of corresponding computer-implemented methods will also be provided in connection with FIG. 3.

FIG. 1 is a block diagram of an example system 100 for contextual gesture-based control of connected devices. As illustrated in this figure, example system 100 may include one or more modules 102 for performing one or more tasks. As will be explained in greater detail below, modules 102 may include a receiving module 104 that may receive, from a wearable included in a controlled network, data representative of a gesture executed by a wearer of the wearable. Additionally, example system 100 may also include a recognizing module 106 that may recognize, based on the data representative of the gesture, the gesture executed by the wearer.

As also shown in FIG. 1, example system 100 may include an identifying module 108 that may identify, via at least one location sensor included in the controlled network, a physical location of the wearer. Additionally, example system 100 may also include a directing module 110 that may direct, based on the gesture executed by the wearer and the physical location of the wearer, a management device included in the controlled network to execute a management action.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate contextual gesture-based control of connected devices. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also illustrated in FIG. 1, example system 100 may also include one or more stores of data, such as data store 140. Data store 140 may represent portions of a single data store or computing device or a plurality of data stores or computing devices. In some embodiments, data store 140 may be a logical container for data and may be implemented in various forms (e.g., a database, a file, file system, a data structure, and the like). Examples of data store 140 may include, without limitation, one or more files, file systems, data stores, databases, and/or database management systems such as an operational data store (ODS), a relational database, a NoSQL database, a NewSQL database, and/or any other suitable organized collection of data.

In at least one example, data store 140 may include gesture recognition data 142 that may include information associated with recognizing, recognizing gestures executed by wearers of wearable devices. For example, gesture recognition data 142 may include data associated with gestures, gesture patterns, data patterns representative of gestures, one or more mathematical models for recognizing gestures based on received data, and so forth.

Additionally, as shown in FIG. 1, data store 140 may also include management data 144 that may include data for managing connected devices, such as one or more application programming interfaces (APIs) for providing commands to and/or receiving data from one or more connected devices, one or more configurations of a set of connected devices, one or more programs for executing one or more management actions, and so forth. By way of illustration, in some examples, management data 144 may include data representative of a configuration of, and/or one or more methods of interacting electronically and/or programmatically with, one or more smart home devices.

In some examples, data store 140 may also include contextual data 146 that may include data related to and/or associated with a context associated with a wearer and that may be analyzed by one or more of modules 102 (e.g., directing module 110) to identify a context associated with a wearer (e.g., at a time of execution of the gesture). As will be described in greater detail below, this contextual data may include any suitable present and/or historical data associated with the wearer and/or an additional user may also access and/or interact with devices in the controlled network (an “additional user”) including, without limitation, location tracking data associated with the wearer and/or the additional user, habit data associated with the wearer and/or the additional user, time data, temperature data, media data, media consumption data, smart home device data, and so forth.

As is further shown in FIG. 1, example system 100 may also include a wearable 150. In some examples, a “wearable” or “wearable device” generally includes devices designed and/or intended to be worn by a wearer and/or integrated into clothing. These devices may have the ability to connect to the internet, sync with other devices (e.g., mobile phones, personal computers, tablet computers, and the like) and provide a variety of features including, but not limited to, tracking physical activity (e.g., steps, heart rate, calories burned, and the like), monitoring biometric information (e.g., blood pressure, blood glucose levels, sleep quality, and the like), providing notifications (e.g., voice calls, emails, text messages, reminders, and the like), supporting navigation (e.g., via positioning systems, Wi-Fi, triangulation, and the like), making contactless payments, voice control, and/or gesture recognition.

Smart rings are a specific type of wearable technology that may be worn on a wearer's finger, similar to a traditional ring. They can be designed to provide various functionalities like those mentioned above and are often focused on discrete or minimalist design to maintain the outward style aspect of a ring while adding smart capabilities. Some may even include bio-sensing features such as measuring stress, body temperature, or providing an electrocardiogram (ECG). These features can vary greatly depending on the particular make and model of the smart ring, and hence this disclosure is not limited to any particular wearable device.

In additional or alternative examples, a “wearable” may include any device capable of (1) gathering data representative of a gesture executed by a wearer of the wearable, and (2) transmitting that data to one or more of modules 102 (e.g., receiving module 104), such as a smartphone, an outside-in tracking system, an inside-out tracking system, a computer vision tracking system, and so forth.

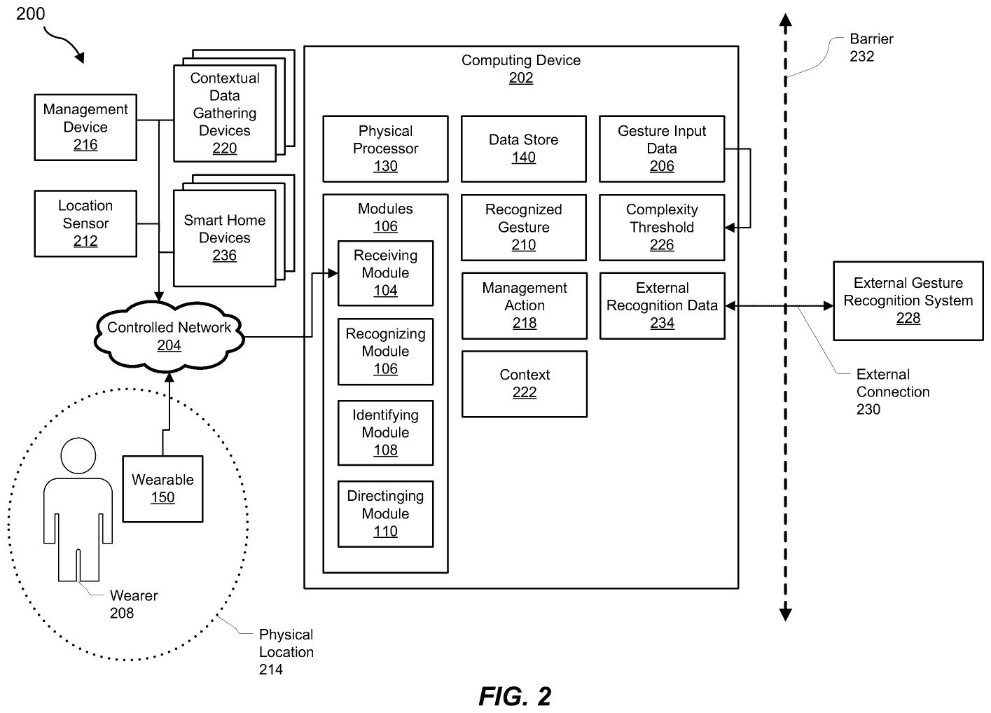

Example system 100 in FIG. 1 may be implemented in a variety of ways. For example, all or a portion of example system 100 may represent portions of an example system 200 (“system 200”) in FIG. 2. FIG. 2 is a block diagram of an example system 200 that implements a system for contextual gesture-based control of connected devices. As shown in FIG. 2, system 200 may include a computing device 202 in communication with wearable 150 via controlled network 204. In at least one example, computing device 202 may be programmed with one or more of modules 102.

In at least one embodiment, one or more modules 102 from FIG. 1 may, when executed by computing device 202, computing device 202 to perform one or more operations to enable contextual gesture-based control of connected devices. For example, as will be described in greater detail below, receiving module 104 may cause computing device 202 to receive, from a wearable (e.g., wearable 150) included in a controlled network (e.g., controlled network 204), data representative of a gesture (e.g., gesture input data 206) executed by a wearer (e.g., wearer 208) of the wearable.

Additionally, recognizing module 106 may cause computing device 202 to recognize, based on the data representative of the gesture, the gesture executed by the wearer (e.g., recognized gesture 210). Furthermore, identifying module 108 may cause computing device 202 to identify, via at least one location sensor included in the controlled network (e.g., location sensor 212), a physical location of the wearer (e.g., physical location 214). Moreover, directing module 110 may cause computing device 202 to direct, based on the gesture executed by the wearer and the physical location of the wearer, a management device included in the controlled network (e.g., management device 216) to execute a management action (e.g., management action 218).

Furthermore, in some examples, one or more of modules 102 (e.g., directing module 110) may also gather, via at least one contextual data gathering device (e.g., contextual data gathering devices 220) communicatively coupled to the management device via the controlled network, additional contextual data associated with the wearer (e.g., contextual data 146). One or more of modules 102 (e.g., directing module 110) may further analyze the additional contextual data to identify a context associated with the wearer (e.g., context 222).

In some additional examples, one or more of modules 102 (e.g., recognizing module 106) may recognize a gesture locally. In additional or alternative examples, one or more of modules 102 (e.g., recognizing module 106) may determine, based on the data representative of the gesture executed by the wearer of the wearable, that the gesture exceeds a predetermined degree of gesture complexity (e.g., gesture complexity threshold 226). In such examples, the one or more modules 102 (e.g., recognizing module 106) may (1) transmit the data representative of the gesture to an external gesture recognition system (e.g., external gesture recognition system 228) that is external to the controlled network (e.g., via external connection 230 through barrier 232), and (2) receive, from the external gesture recognition system, data representative of a recognized gesture (e.g., recognized gesture data 234).

In some examples, the management device may include or represent a home automation management device. In such examples, one or more of modules 102 (e.g., directing module 110) may direct the management device to execute the management action by directing the home automation management device to direct a smart home device (e.g., at least one of smart home devices 236) to execute a smart home function.

Computing device 202 generally represents any type or form of computing device capable of reading and/or executing computer-executable instructions. Examples of computing device 202 include, without limitation, servers, desktops, laptops, tablets, cellular phones, (e.g., smartphones), personal digital assistants (PDAs), multimedia players, embedded systems, wearable devices (e.g., smart watches, smart glasses, and the like), gaming consoles, combinations of one or more of the same, or any other suitable mobile computing device.

Controlled network 204 generally represents any medium or architecture capable of facilitating communication and/or data transfer between computing device 202 and one or more other network-enabled devices. For example, the controlled network 204 can be, but is not limited to, a WiFi network, a local area network (LAN), a wide-area network (WAN), and/or any other type of network that can facilitate connectivity among devices at a location and/or with a cloud service (e.g., Bluetooth™, and the like). Examples of controlled network 204 include, without limitation, an intranet, a WAN, a LAN, a Personal Area Network (PAN), the Internet, Power Line Communications (PLC), a cellular network (e.g., a Global System for Mobile Communications (GSM) network, a code-division multiple access (CDMA) network, a Long-Term Evolution (LTE) network, a Fifth-Generation (5G) network, and the like), universal serial bus (USB) connections, and the like. Controlled network 204 may facilitate communication or data transfer using wireless or wired connections. In some embodiments, controlled network 204 may facilitate communication between computing device 202, wearable 150, location sensor 212, management device 216, contextual data gathering devices 220, and/or smart home devices 236. In at least one embodiment, controlled network 204 may also partially facilitate communication between computing device 202 and external gesture recognition system 228 through barrier 232.

In some examples, controlled network 204 may include not just local physical networks but also software-defined networks (SDNs), virtual private networks (VPNs), or any architecture capable of facilitating communication and data transfer across geographically and/or logically dispersed locations. In some cases, controlled network 204 may not be restricted to a single physically restricted network but can be a collection of interconnected networks that operate as a single entity by virtue of software control or through virtual connections. This arrangement can enable the user to cause a management action to be taken in a physically remote location, provided the devices are part of the same software-defined or virtual network.

Furthermore, the control of connected devices may not be limited to a single network. In some examples, actions triggered by a user gesture may result in a message being sent to another network where the corresponding action is taken based on the message received. In this way, controlled network 204 represents any medium or architecture capable of facilitating communication, data transfer, or remote management of connected devices, across various physical or virtual networks.

In at least one example, computing device 202 may be a computing device programmed with one or more of modules 102. All or a portion of the functionality of modules 102 may be performed by computing device 202 and/or any other suitable computing system. As will be described in greater detail below, one or more of modules 102 from FIG. 1 may, when executed by at least one processor of computing device 202, may enable computing device 202 to provide contextual gesture-based control of connected devices.

Many other devices or subsystems may be connected to example system 100 in FIG. 1 and/or example system 200 in FIG. 2. Conversely, all of the components and devices illustrated in FIGS. 1 and 2 need not be present to practice the embodiments described and/or illustrated herein. The devices and subsystems referenced above may also be interconnected in different ways from those shown in FIG. 2. Example systems 100 and 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 3 is a flow diagram of an example method 300 for contextual gesture-based control of connected devices. The steps shown in FIG. 3 may be performed by any suitable computer-executable code and/or computing system, including example system 100 in FIG. 1, example system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may receive, from a wearable included in a controlled network, data representative of a gesture executed by a wearer of the wearable. For example, receiving module 104 may, as part of computing device 202 in FIG. 2, cause computing device 202 to receive, from wearable 150 included in controlled network 204, gesture input data 206 representative of a gesture executed by wearer 208.

Receiving module 104 may receive gesture input data 206 from wearable 150 in a variety of contexts. For example, as shown in FIG. 2, wearable 150 may be connected to controlled network 204. Hence, wearable 150 may transmit gesture input data 206 to receiving module 104 via controlled network 204.

In some examples, a “gesture” may include any physical movement or pose made by a wearer of a wearable device. In some examples, a gesture may include one or more movements of a user's hand or other body part including, without limitation, movements like swiping a hand in a certain direction, making a specific hand shape, and so forth. In some examples, wearable 150 may be configured to record movement information as gesture input data (e.g., gesture input data 206) and transmit the gesture input data to receiving module 104.

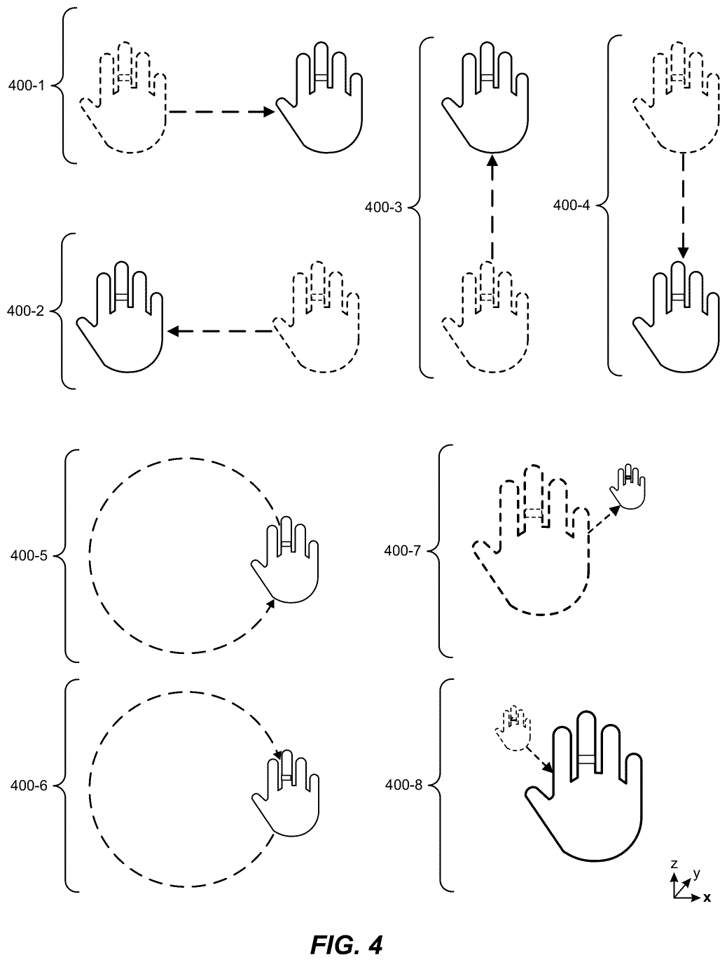

FIG. 4 illustrates example gestures 400 (e.g., example gesture 400-1 through example gesture 400-8). In each of these various example gestures, a wearer of a wearable device executes a gesture starting at a position indicated by a hand in dashed lines and passing the wearer's had along a path indicated by a dashed line and concluding at a position indicated by a hand in solid lines. The inclusion of example gestures 400 herein is not intended to limit the scope of this disclosure, as example gestures 400 are not an exhaustive list of all gestures that may be executed by wearer 208, recorded by wearable 150, and/or included as part of gesture input data 206. Indeed, gesture input data 206, recognized gesture 210, and/or recognized gesture data 234 may include or represent any suitable wearer motion that may be captured by one or more sensors included in wearable 150. For example, such motion can correspond to fingers, arm movements that cause the hand to move, rotations, pivoting, and the like, or some combination thereof. Indeed, the speed, velocity and/or acceleration, as well as the angle and/or trajectory, inter alia, of the motion can be a factor in a type of gesture.

Although many of the examples provided herein may be directed to hand- or arm-based gestures, it may be noted that a gesture may encompass a broader range of physical movements beyond those executed with hands or arms. Indeed, any movement of a wearer's body may potentially be classified as a gesture, without limitation. This may include movements carried out with the legs, such as a kick, step, or pivot, or even movements involving the torso, such as a twist or bend. A wearable device (e.g., wearable 150), equipped with appropriate sensors, may be designed to record these movements as input data, regardless of the body part involved. The wearable device (e.g., one or more sensors included in the wearable device and/or one or more sensors external to the wearable device) may captures details like speed, velocity, acceleration, angle, and trajectory of these movements. Whether a wave of a hand, a nod of the head, a twist of the torso, or a kick of the leg, embodiments of the systems and methods disclosed herein may interpret any bodily actions as gesture input data.

In some examples, a gesture may not necessarily be intentional or consciously performed by the wearer with the express purpose of gesturing. Indeed, the gesture input data 206 could represent movements or actions performed by the wearer for reasons other than communication or command execution. By way of example, and without limitation, regular daily activities such as brushing teeth, waving to a friend, or adjusting a piece of clothing may all be captured as gestures by wearable 150. These activities, while not intended as gestures, result in distinctive movements that a wearable device's sensors may capture and/or encode as gesture input data. Such data, when processed by receiving module 104 and/or recognizing module 106, may be interpreted as specific gestures. Embodiments of the systems and methods disclosed herein are thus not limited to recognizing only those movements that are expressly performed as gestures but have the capacity to interpret a broad range of wearer movements, intentional or otherwise.

Returning to FIG. 3, at step 320, one or more of the systems described herein may recognize, based on the data representative of the gesture, the gesture executed by the wearer. For example, recognizing module 106 may, as part of computing device 202 in FIG. 2, cause computing device 202 to recognize, based on gesture input data 206, the gesture executed by wearer 208.

Recognizing module 106 may recognize the gesture executed by wearer 208 in a variety of contexts. In some examples, recognizing module 106 may be configured to recognize the gesture locally. In additional or alternative examples, recognizing module 106 may determine that the gesture exceeds a predetermined degree of gesture complexity. For example, gesture input data 206 may indicate that the gesture includes more than a single action or movement. Additionally or alternatively, gesture input data 206 may indicate that recognition of the gesture may require a high degree of precision. Additionally or alternatively, gesture input data 206 may indicate that the gesture includes a sequence of actions or motions rather than a single action or motion. Hence, in some examples, recognizing module 106 may determine, based on gesture input data 206, that the gesture exceeds a predetermined degree of complexity, and may transmit, via an external connection like external connection 230, gesture input data 206 to an external gesture recognition system such as external gesture recognition system 228.

External gesture recognition system 228 may be configured to recognize, from gesture input data 206 more complex or complicated gestures using increased computing resources, specialized gesture recognition models (e.g., machine learning models), and so forth. External gesture recognition system 228 may be referred to as “external” in that it may be physically or logically distinct and/or isolated from one or more devices connected to controlled network 204. This may be indicated in FIG. 2 by barrier 232.

In some examples, external gesture recognition system 228 may be designed and/or configured to handle gesture recognition tasks that exceed a certain predetermined degree of complexity, which could be beyond the capabilities of the local recognizing module 106. For instance, gestures that incorporate multiple actions or movements, require a high level of precision, or involve sequences of actions or motions may be directed to external gesture recognition system 228 for analysis. Utilizing increased computing resources and specialized models, such as machine learning algorithms that may require additional computing resources, external gesture recognition system 228 may accurately recognize these intricate gestures. As the term “external” suggests, the system is physically or logically separate from one or more devices connected to controlled network 204, ensuring a level of isolation that can be beneficial for data security and system performance. After analyzing the gesture input data 206, the system provides back to the recognizing module 106 data representative of the recognized gesture (e.g., recognized gesture data 234). Hence, recognizing module 106 may receive, from external gesture recognition system 228 via external connection 230, data representative of a recognized gesture, indicated in FIG. 2 by recognized gesture data 234.

Returning to FIG. 3, at step 330, one or more of the systems described herein may identify, via at least one location sensor included in the controlled network, a physical location of the wearer. For example, identifying module 108 may, as part of computing device 202 in FIG. 2, cause computing device 202 to identify, via location sensor 212 included in controlled network 204, physical location 214 of wearer 208.

In some examples, a “location sensor” may include a device or technology used to detect the presence or location of individuals, objects, or other devices within an environment. A location sensor may use a variety of methods to sense location such as, without limitation, infrared, ultrasonic, radio frequency identification (RFID), or Wi-Fi signals. Location sensor 212 may be capable of any or all of presence detection, location tracking, device tracking, activity recognition, and so forth.

Identifying module 108 may identify physical location 214 of wearer 208 in a variety of contexts. For example, location sensor 212 may include an RFID sensor that may report physical location 214 of wearer 208 to identifying module 108 via controlled network 204. Additionally or alternatively, location sensor 212 may include a Wi-Fi access point that services a predetermined or predefined area. Wearable 150 may be connected to the Wi-Fi access point at the time that wearer 208 executes the gesture. Location sensor 212 may therefore report to identifying module 108 via controlled network 204 that wearer 208 is located in the predetermined or predefined area.

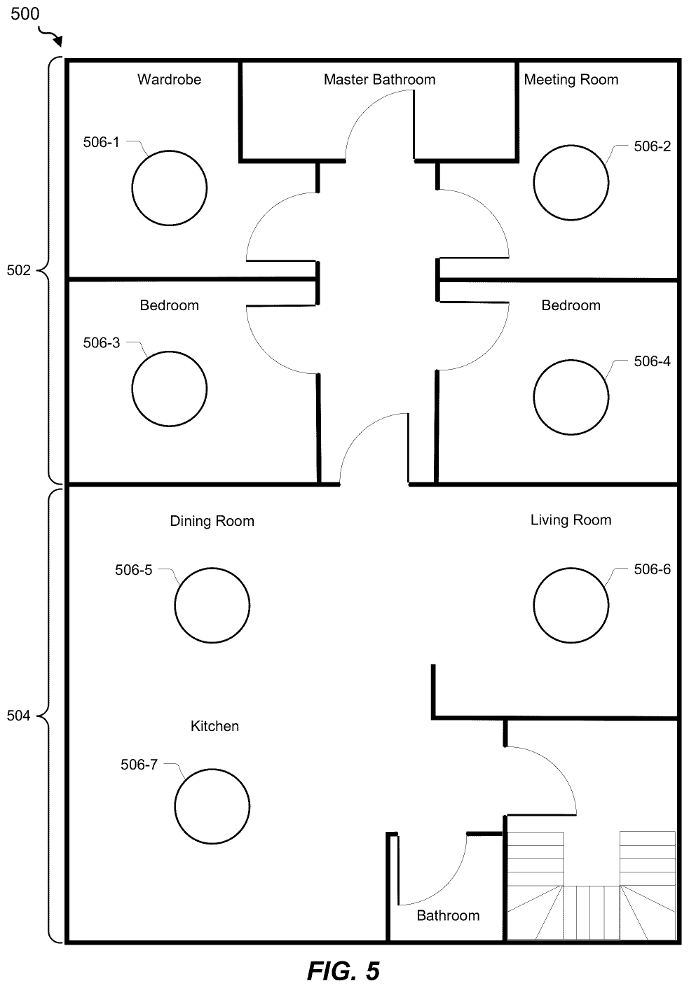

Identifying module 108 may identify physical location 214 with varying degrees of accuracy. By way of illustration, FIG. 5 shows a floorplan 500 of an example smart home with a first zone 502 and a second zone 504. Various location indicators 506 (e.g., location indicator 506-1 through location indicator 506-7) included in floorplan 500 indicate locations within first zone 502 and second zone 504.

Continuing with this illustration, if wearer 208 makes a first gesture using wearable 150 while at location indicator 506-7, identifying module 108 may identify physical location 214 of wearer 208 as within a home represented by floorplan 500, within second zone 504, and/or at location indicator 506-7.

In some examples, identifying module 108 may identify physical location 214 using alternative methods when direct location data is unavailable. For instance, in scenarios where wearable 150 does not share its location, such as when GPS data is not provided, identifying module 108 may leverage other network operational data to estimate physical location 214. By way of illustration, if wearable 150 is connected to a wireless network and transmits gesture data, a signal strength, along with other network characteristics, can provide valuable location data. The strength of the network signal between wearable 150 and an access point can help infer a distance between the two. Furthermore, if multiple access points are available, techniques such as triangulation can be used to estimate the location of the wearable more accurately. This way, even without explicit location data, identifying module 108 may infer the wearer's physical location (e.g., physical location 214) based on network operational parameters, ensuring a continuous contextual understanding of wearer's gestures.

Returning to FIG. 3, at step 340, one or more of the systems described herein may direct, based on the gesture executed by the wearer and the physical location of the wearer, a management device included in the controlled network to execute a management action. For example, directing module 110 may, as part of computing device 202 in FIG. 2, direct, based on recognized gesture 210 executed by wearer 208 wearer and physical location 214 of wearer 208, management device 216 to execute management action 218.

In some examples, a “management device” may include any component or system within a controlled network, such as a smart home environment, that oversees and coordinates the operations of other devices within the network. In some examples, a “management action” may include any action that a management device may direct a component or system within a controlled network to execute. By way of example, a management action may include directing a smart speaker to play music, adjusting the brightness of smart lighting, enabling or disabling a security system, or providing data about the status of a device.

The management device may serve as a central hub or control system of a smart home, receiving inputs from various devices and sensors (e.g., wearable 150, location sensor 212, contextual data gathering devices 220, smart home devices 236, and the like) processing this information, and then directing the operations of the smart home devices based on this information. Hence, in some examples, a management device may be referred to as a “home automation management device”. In some examples, management actions may include, without limitation, transitioning smart home devices between different operational states, collecting data about the operational condition of a device, or presenting data regarding a device's operational condition via an output device (e.g., a display or speaker). A smart home device (e.g., one or more of smart home devices 236) may include, without limitation, a smart speaker device, a smart lighting device, a smart switch, a security system, a home appliance, a networking device, a landscaping device, an entertainment device, and so forth.

By identifying a location of a wearer of a wearable device in addition to recognizing a gesture executed by the wearer while at the location, embodiments of the systems and methods described herein may vary actions executed in response to the recognized gesture based on the location of the user when the user executed the action.

For example, at a first time, wearer 208 may execute, while at location indicator 506-7, example gesture 400-5. Receiving module 104 may receive, from wearable 150, gesture input data 206, and recognizing module 106 may recognize, based on gesture input data 206, gesture 400-6. Likewise, identifying module 108 may identify that wearer 208 is located within first zone 502. This may cause directing module 110 to direct a smart speaker in first zone 502 to increase in volume.

At a second time, wearer 208 may execute gesture 400-6 again, this time while at location indicator 506-3. In this context, instead of directing the smart speaker in first zone 502 to increase in volume, directing module 110 may direct a dimmable light switch near location indicator 506-3 to increase light output by 5 percent.

In some examples, one or more of modules 102 (e.g., directing module 110) may also gather, via at least one contextual data gathering device (e.g., contextual data gathering devices 220), additional contextual data associated with the wearer. The additional contextual data may include any of a variety of information types that may provide detail about the actions, environment, or physiological state of wearer 208. In some examples, a “contextual data gathering device” may include a device within a controlled network, such as controlled network 204, that collects additional data associated with a wearer of a wearable device (e.g., wearer 208). Examples of contextual data gathering devices may include, without limitation: (1) a network monitoring device that tracks network activity within a controlled network, (2) a sleep monitoring device that collects data about a wearer's sleep patterns, such as the length and quality of sleep, or times of sleep and wakefulness, (3) a biometric data monitoring device that tracks physiological data from the wearer, such as heart rate, body temperature, or blood pressure, (4) a location tracking device that provides information about users' movements within the controlled network's range, and (5) statistical analysis device configured to analyze the collected data to identify patterns in the wearer's actions, behaviors, or physiological responses.

In some embodiments, a potential purpose of this data collection can be, but is not limited to, identifying and/or determining a context of the wearer's actions or situation, and to use that information to enhance the functionality and responsiveness of the system. Hence, in some embodiments, directing module 110 may (1) analyze the additional contextual data associated with the wearer to identify a context associated with the wearer, and (2) direct the management device to execute the management action based on the context.

For example, a wearer of a wearable computing device (e.g., a smart ring, a smart watch, and the like) may arrive to their smart home after work. The wearer may execute, using the wearable, an upward-swiping gesture. An embodiment of the present disclosure may receive, from the wearable, data representative of the gesture, and may recognize the gesture. The embodiment may also identify a location of the user as within a first of two zones in the smart home: a living room. Based on the gesture and the wearer's location in the living room, the embodiment may direct a management system (e.g., a smart home management system) to turn on the lights in the living room to a full brightness and may direct a smart speaker to play the wearer's favorite song.

As an additional example, the wearer may arrive to their smart home late at night, and their spouse may be asleep in a bedroom in the second of the two zones. The wearer may walk into a second zone and may execute, using the wearable, the upward swiping gesture. However, in this example, the embodiment may identify the location of the wearer as in the second zone, and may, via additional contextual information such as the time of day and an indication of the presence of an additional, sleeping person in the bedroom, bring a set of footlights in the bedroom up to 10 percent and start no music.

The disclosed systems and methods may provide one or more advantages over traditional options for controlling connected devices by offering a new paradigm in user-device interaction, shifting away from traditional controls or smartphone-dependent commands and towards more intuitive, gesture-based control in smart environments. Embodiments may enable a more natural and accessible form of interaction, doing away with the need to navigate through device interfaces or smartphone apps.

Moreover, embodiments of the systems and methods disclosed herein may employ, and benefit from, an enhanced contextual understanding beyond mere gesture recognition to appreciate the context within which the user performs a gesture, such as location, user habits, and behaviors. This may allow for a more personalized user experience, with responses from connected devices that are relevant and tailored to each unique situation.

Furthermore, unlike voice recognition systems, which may constantly listen and thus raise privacy concerns, gesture-based controls can offer an interaction mode that feels less invasive. Users can relay commands without the risk of being overheard or having their conversations inadvertently recorded.

Another significant benefit is the broad accessibility of the gesture-based system. As it does not rely on language or vocal abilities, it is more universal and can be used by diverse user groups. This stands in contrast to voice recognition systems that may struggle with understanding different accents, languages, or dealing with speech impairments.

A particularly innovative feature of disclosure is an ability of embodiments thereof to adapt actions based on context. For example, an embodiment's understanding of a user's location means that the same gesture can elicit different responses depending on the user's current circumstances or needs.

Accordingly, the use of the secondary edge's computational power (i.e., via offloading complex gesture recognition tasks to an external computing platform) may improve service quality by running more sophisticated machine learning models. This may lead to more accurate gesture recognition and ultimately, a more seamless and satisfying user experience.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive gesture input data to be transformed, transform the gesture input data, output a result of the transformation to identify a gesture executed by a wearer of a wearable device, use the result of the transformation to direct a management device to execute a management action, and store the result of the transformation to track a history of gesture input. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

Embodiments of the instant disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, from a wearable included in a controlled network, data representative of a gesture executed by a wearer of the wearable;
recognizing, based on the data representative of the gesture, the gesture executed by the wearer;
identifying, via at least one location sensor, a physical location of the wearer; and
directing, based on the gesture executed by the wearer and the physical location of the wearer, a management device included in the controlled network to execute a management action.

2. The computer-implemented method of claim 1, wherein:
the computer-implemented method further comprises:
gathering, via at least one contextual data gathering device communicatively coupled to the management device via the controlled network, additional contextual data associated with the wearer; and
analyzing the additional contextual data associated with the wearer to identify a context associated with the wearer; and
directing of the management device to execute the management action is further based on the context.

3. The computer-implemented method of claim 2, wherein the at least one contextual data gathering device comprises at least one of:
a network monitoring device;
a sleep monitoring device;
a biometric data monitoring device;
a location tracking device; and
a statistical analysis device that incorporates gathered data to identify one or more patterns in wearer actions.

4. The computer-implemented method of claim 1, wherein recognizing the gesture executed by the wearer of the wearable comprises recognizing the gesture via a local gesture recognition device within the controlled network.

5. The computer-implemented method of claim 1, wherein recognizing the gesture executed by the wearer of the wearable comprises:
determining, based on the data representative of the gesture executed by the wearer of the wearable, that the gesture exceeds a predetermined degree of gesture complexity;
transmitting the data representative of the gesture to an external gesture recognition system external to the controlled network; and
receiving, from the external gesture recognition system, data representative of a recognized gesture.

6. The computer-implemented method of claim 1, wherein the wearable comprises a smart ring device.

7. The computer-implemented method of claim 1, wherein the management device comprises a home automation management device.

8. The computer-implemented method of claim 7, wherein the home automation management device executes the management action by directing a smart home device communicatively coupled to the home automation management device to execute a smart home function.

9. The computer-implemented method of claim 8, wherein the smart home device comprises at least one of:
a smart speaker device;
a smart lighting device;
a smart switch;
a security system;
a home appliance;
a networking device;
a landscaping device; and
an entertainment device.

10. The computer-implemented method of claim 8, wherein directing the smart home device to execute the smart home function comprises at least one of:
directing the smart home device to transition from a first operational state to a second operational state;
directing the smart home device to provide data regarding a present operational condition of the smart home device to the management device; and
directing the home automation management device to present the data regarding the present operational condition of the smart home device via an output device.

11. A system comprising:
a receiving module, stored in memory, that receives, from a wearable included in a controlled network, data representative of a gesture executed by a wearer of the wearable;
a recognizing module, stored in memory, that recognizes, based on the data representative of the gesture, the gesture executed by the wearer;
an identifying module, stored in memory, that identifies, via at least one location sensor, a physical location of the wearer;
a directing module, stored in memory, that directs, based on the gesture executed by the wearer and the physical location of the wearer, a management device included in the controlled network to execute a management action; and
at least one physical processor that executes the receiving module, the recognizing module, the identifying module, and the directing module.

12. The system of claim 11, wherein the directing module further:
gathers, via at least one contextual data gathering device communicatively coupled to the management device via the controlled network, additional contextual data associated with the wearer;
analyzes the additional contextual data associated with the wearer to identify a context associated with the wearer; and
directs the management device to execute the management action based on the context.

13. The system of claim 12, wherein the at least one contextual data gathering device comprises at least one of:
a network monitoring device;
a sleep monitoring device;
a biometric data monitoring device;
a location tracking device; and
a statistical analysis device that incorporates gathered data to identify one or more patterns in wearer actions.

14. The system of claim 11, wherein the recognizing module recognizes the gesture executed by the wearer of the wearable by recognizing the gesture via a local gesture recognition device within the controlled network.

15. The system of claim 11, wherein the recognizing module recognizes the gesture executed by the wearer of the wearable by:
determining, based on the data representative of the gesture executed by the wearer of the wearable, that the gesture exceeds a predetermined degree of gesture complexity;
transmitting the data representative of the gesture to an external gesture recognition system external to the controlled network; and
receiving, from the external gesture recognition system, data representative of a recognized gesture.

16. The system of claim 11, wherein:
the management device comprises a home automation management device; and
the home automation management device executes the management action by directing a smart home device communicatively coupled to the home automation management device to execute a smart home function.

17. The system of claim 16, wherein directing the smart home device to execute the smart home function comprises at least one of:
directing the smart home device to transition from a first operational state to a second operational state;
directing the smart home device to provide data regarding a present operational condition of the smart home device to the management device; and
directing the home automation management device to present the data regarding the present operational condition of the smart home device via an output device.

18. A non-transitory computer-readable storage medium comprising computer-readable instructions that, when executed by at least one processor of a computing system, cause the computing system to:
receive, from a wearable included in a controlled network, data representative of a gesture executed by a wearer of the wearable;
recognize, based on the data representative of the gesture, the gesture executed by the wearer;
identify, via at least one location sensor, a physical location of the wearer; and
direct, based on the gesture executed by the wearer and the physical location of the wearer, a management device included in the controlled network to execute a management action.

19. The non-transitory computer-readable storage medium of claim 18, further comprising computer-readable instructions that, when executed by the at least one processor of the computing system, further cause the computing system to:
gather, via at least one contextual data gathering device communicatively coupled to the management device via the controlled network, additional contextual data associated with the wearer; and
analyze the additional contextual data associated with the wearer to identify a context associated with the wearer; and
direct the management device to execute the management action based on the context.

20. The non-transitory computer-readable storage medium of claim 18, further comprising computer-readable instructions that, when executed by the at least one processor of the computing system, further cause the computing system to recognize the gesture executed by the wearer of the wearable by:
determining, based on the data representative of the gesture executed by the wearer of the wearable, that the gesture exceeds a predetermined degree of gesture complexity;
transmitting the data representative of the gesture to an external gesture recognition system external to the controlled network; and
receiving, from the external gesture recognition system, data representative of a recognized gesture.
